(19) United States
(12) Patent Application Publication
(10) Pub. No.: US 2026/0009525 A1
(43) Pub. Date: Jan. 8, 2026

(54) LAMP STAND

(71) Applicant: TILTA INC., Burbank, CA (US)

(72) Inventors: Sen WU, Shenzhen (CN); Wenping ZENG, Shenzhen (CN); Kefeng ZHOU, Shenzhen (CN)

(21) Appl. No.: 19/261,431

(22) Filed: Jul. 7, 2025

(30) Foreign Application Priority Data
Jul. 8, 2024 (CN) 2024216272594

(51) Int. Cl. F21V 21/14; F21V 23/00

(52) U.S. Cl. CPC F21V 21/14; F21V 23/002

(57) ABSTRACT

A lamp stand includes a support frame, with an installation position for mounting a light fixture provided thereon. Inside the support frame, a wire channel and a housing cavity are arranged. A first circuit board is provided within the housing cavity, and the wire channel is in communication with the housing cavity. Electrical wires are arranged within the wire channel. A first outlet port for electrical connection with the light fixture is provided on the support frame near the installation position. The first outlet port is electrically connected to the electrical wires within the wire channel, and one end of the electrical wires away from the first outlet port extends into the housing cavity and is electrically connected to the first circuit board.

### CROSS-REFERENCE TO RELATED APPLICATIONS

The present application for patent claims priority to and the benefit of pending Chinese Application No. 2024216272594, filed Jul. 8, 2024, and hereby expressly incorporated by reference herein as if fully set forth below in its entirety and for all applicable purposes.

### TECHNICAL FIELD

The present disclosure pertains to the field of photographic equipment, specifically to a lamp stand.

### INTRODUCTION

During the photographic process, lights are often used in combination to achieve the desired shooting effects. The installation and support of these lights are typically accomplished through lamp stands. Existing lamp stands generally consist of two arms, with lights installed between them for support. Since both the lights and lamp stands are electronic devices, they are connected by electrical wires. However, in existing lamp stands, these electrical wires are usually directly exposed. When adjusting the position of the lights, the wires may move along with the lights, potentially becoming entangled with the lamp stand.

For example, a shooting support frame includes a support frame body and a light source. The light source is mounted on the support frame body, which includes a vertically arranged support section, a connecting section extending horizontally from the top end of the support section, and a light box connected to the front end of the connecting section, with the light source being installed in the light box. The support frame body disclosed in this prior application exhibits the same defects as those in the existing technology mentioned above.

### BRIEF SUMMARY

To address the aforementioned issues, aspects of the present disclosure provide a lamp stand and techniques, which can store the wires internally and prevent wire entanglement when adjusting the position of the lights.

In some aspects, the technical solution of the present disclosure is as follows.

A lamp stand includes a support frame; an installation position for mounting a light fixture is provided on the support frame; inside the support frame, a wire channel and a housing cavity are arranged; a first circuit board is provided within the housing cavity, and the wire channel is interconnected with the housing cavity; electrical wires are arranged within the wire channel; a first outlet port for electrical connection with the light fixture is provided on the support frame near the installation position; the first outlet port is electrically connected to the electrical wires within the wire channel, and one end of the electrical wires away from the first outlet port extends into the housing cavity and is electrically connected to the first circuit board.

### BRIEF DESCRIPTION OF THE DRAWINGS

FIG. 1 is a diagram illustrating a lamp stand with a light fixture installed according to some aspects of the disclosure.

FIG. 2 is a diagram illustrating the lamp stand according to some aspects of the disclosure.

FIG. 3 is a cross-sectional view of the lamp stand according to some aspects of the disclosure.

FIG. 4 is an enlarged view of area A in FIG. 3.

FIG. 5 is an exploded view illustrating a second circuit board and a connection channel according to some aspects of the disclosure.

FIG. 6 is an exploded view of the light fixture and the lamp stand according to some aspects of the disclosure.

Legend:
1. support frame; 11. wire channel; 111. first wire channel; 112. second wire channel; 12. housing cavity; 121. first circuit board; 122. connection port; 123. wire clamp; 124. first wiring hole; 125. second wiring hole; 13. first outlet port; 14. first arm; 141. first telescopic section; 142. first connection end; 15. second arm; 151. second telescopic section; 152. second connection end; 16. first mounting fixture; 17. second mounting fixture; 18. tilt drive assembly; 181. motor; 182. third control board; 19. connecting body;
2. control box; 21. access port; 22. second circuit board; 23. second outlet port; 24. connection channel;
3. mounting position; 31. slider rail; 32. locking groove;
4. light fixture; 41. sliding groove; 42. locking lever; 43. eccentric head;
5. electrical wire; 51. first wire; 52. second wire; 53. first elastic segment; 54. second elastic segment; 55. third wire.

### DETAILED DESCRIPTION

To make the objectives, technical solutions, and aspects of the present disclosure clearer, the following detailed description is provided in conjunction with the accompanying drawings and exemplary embodiments. It should be understood that the specific embodiments described herein are merely for illustrative purposes and do not limit the scope of the present disclosure.

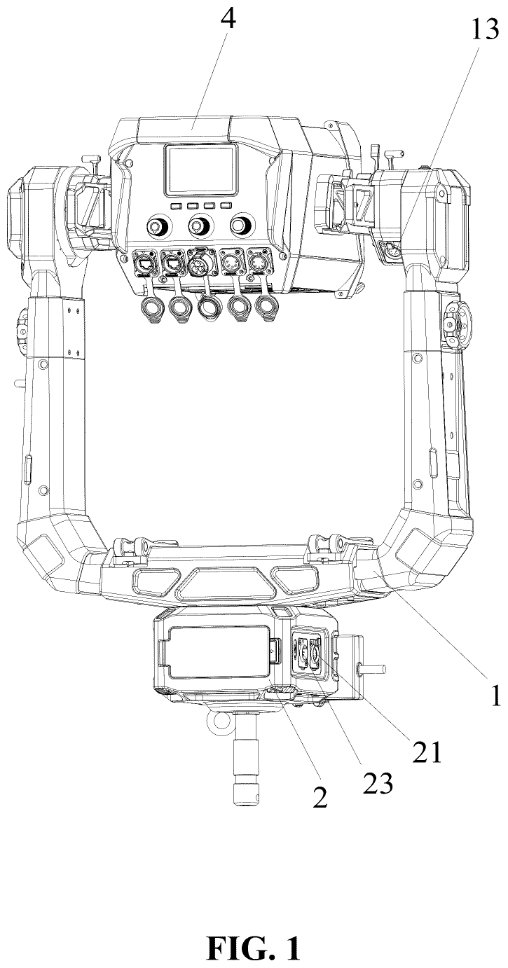

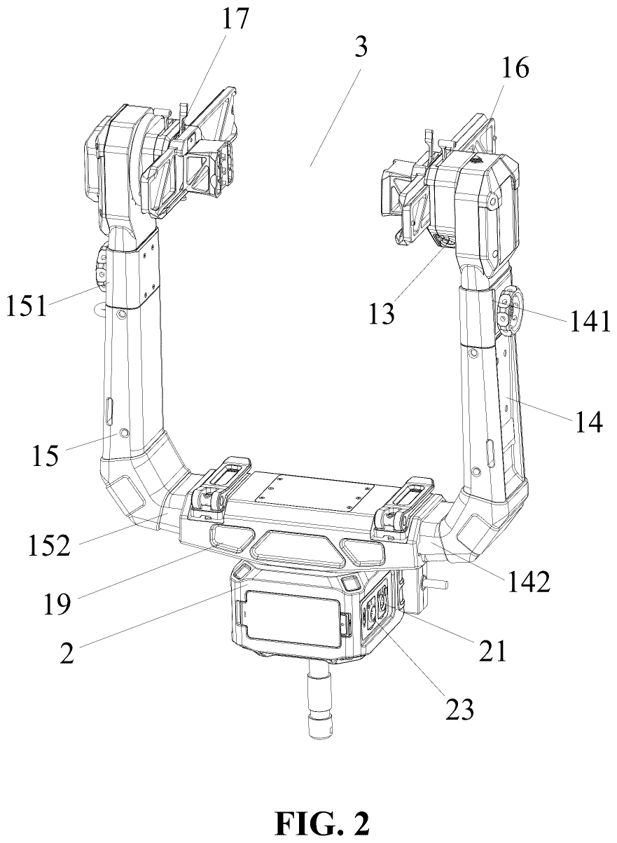

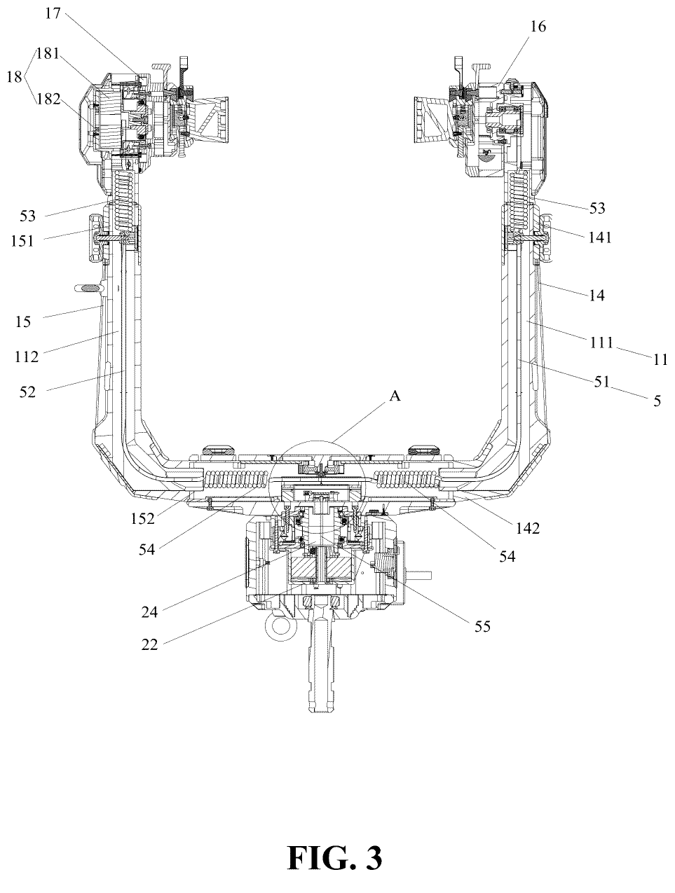

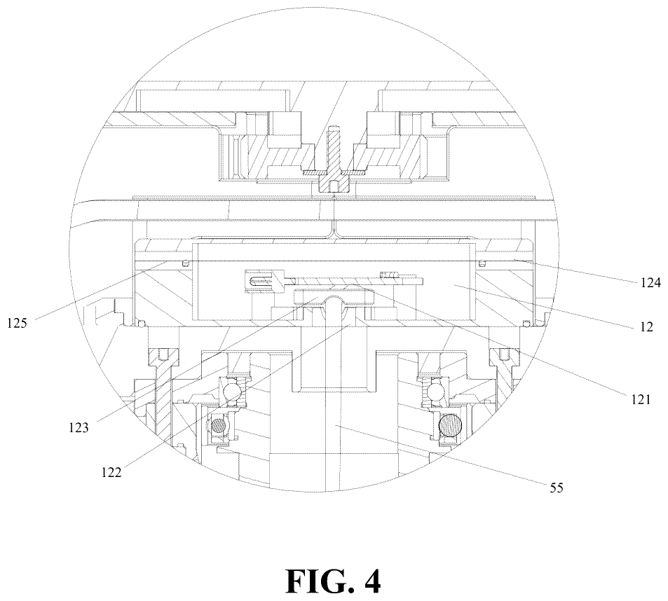

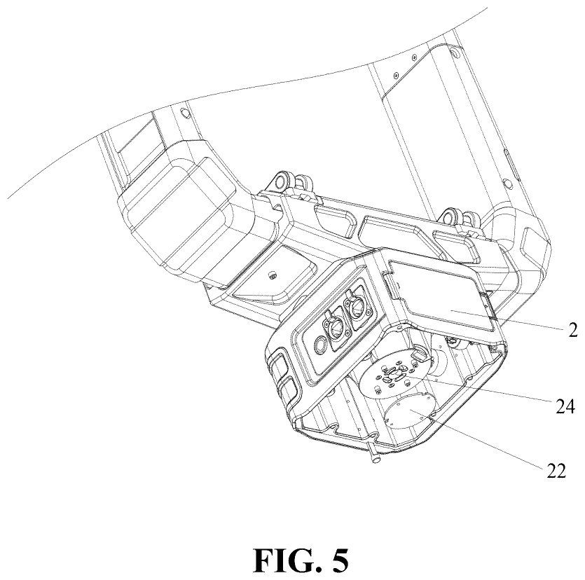

Referring to FIGS. 1-5, aspects of the disclosure provide a lamp stand, including a support frame 1. An installation position 3 for mounting a light fixture 4 is provided on the support frame 1. Inside the support frame 1, a wire channel 11 (see FIG. 3) and a housing cavity 12 (see FIG. 4) can be arranged. A first circuit board 121 is provided within the housing cavity 12, and the wire channel 11 is interconnected with the housing cavity 12. Electrical wires 5 (see FIG. 3) can be arranged within the wire channel 11. A first outlet port 13 for electrical connection with the light fixture 4 is provided on the support frame 1 near the installation position 3. The first outlet port 13 is electrically connected to the electrical wires 5 within the wire channel 11, and one end of the electrical wires 5 away from the first outlet port 13 extends into the housing cavity 12 and is electrically connected to the first circuit board 121 (see FIG. 4).

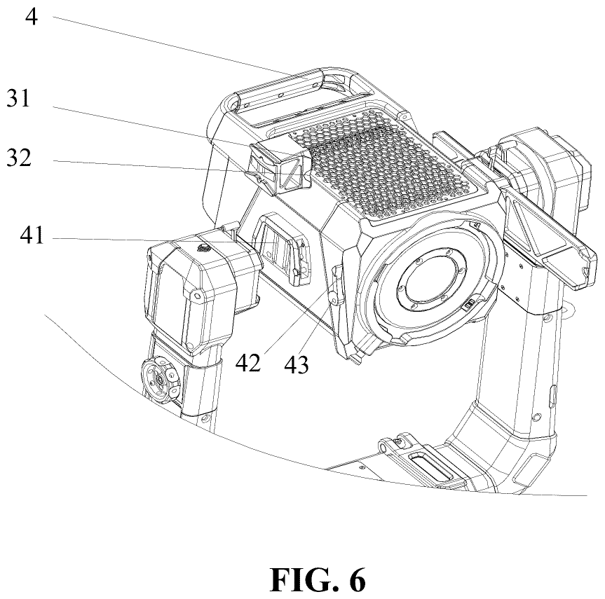

The light fixture 4 is installed at the installation position 3 and is electrically connected to the first outlet port 13. At this point, power and/or control signals can be provided through the electrical wires 5 within the wire channel 11. When the position of the light fixture 4 is adjusted, the electrical wires 5 remain enclosed within the wire channel 11 inside the support frame 1, preventing them from directly being exposed outside the lamp stand or becoming entangled with the lamp stand. In some aspects, referring to FIG. 6, the connection method between the installation position 3 and the light fixture 4 may include threaded connection, sliding groove and slider rail connection, etc. An embodiment uses the sliding groove and slider rail connection as an example. In some aspects, the light fixture 4 includes a sliding groove 41 provided on its sidewall, and the installation position 3 can include a slider rail 31 that slides within the sliding groove 41. The light fixture 4 can also include a locking lever 42 with an eccentric head 43 for locking the slider rail 31 in a secured position. When the locking lever 42 is operated, the eccentric head 43 of the locking lever 42 can move towards the sliding groove 41 to lock the slider rail 31, thereby installing the light fixture 4. In some aspects, the slider rail 31 has a locking groove 32, and the eccentric head 43 of the locking lever 42 can press against the locking groove 32.

In some aspects, the lamp stand further includes a control box 2 connected to the support frame 1. A second circuit board 22 and a third wire 55 are provided within the control box 2. A connection port 122 that penetrates through to the housing cavity 12 is provided on the support frame 1. A connection channel 24 is provided on the control box 2, and the connection channel 24 is connected to the connection port 122. The third wire 55 is electrically connected to the second circuit board 22, and one end of the third wire 55 away from the second circuit board 22 passes through the connection channel 24 and the connection port 122 and is then electrically connected to the first circuit board 121. The third wire 55 connecting the second circuit board 22 of the control box 2 and the first circuit board 121 of the support frame 1, is hidden within the connection channel 24 and the housing cavity 12, making it less susceptible to external interference.

In some aspects, the control box 2 is rotatably connected to the support frame 1. Since the third wire 55 is not exposed outside but passes through the interior of the control box 2 and the support frame 1, it will not become entangled with the lamp stand during rotational adjustment between the control box 2 and the support frame 1.

An access port 21 for electrical connection with an external control console is provided on the control box 2, and the second circuit board 22 is electrically connected to the access port 21. The external control console can control the lamp stand through the access port 21 and also provide power to the lamp stand.

A wire clamp 123 for positioning the third wire 55 is further provided within the housing cavity 12. One end of the third wire 55 away from the second circuit board 22 sequentially passes through the connection channel 24, the connection port 122, and the wire clamp 123 and is then electrically connected to the first circuit board 121. The wire clamp 123 can be configured to position the third wire 55 to avoid excessive clutter in the wiring within the housing cavity 12.

In some aspects, the control box 2 is further equipped with a second outlet port 23 for electrical connection to other lamp stands. The second outlet port 23 is electrically connected to the second circuit board 22.

The inclusion of the second outlet port 23 enables multiple lamp stands to be connected in series, enabling a single external control console to simultaneously supply power to and control multiple lamp stands.

In some aspects, the support frame 1 includes a first arm 14 and a second arm 15. A first mounting fixture 16 is rotatably mounted on the first arm 14, and a second mounting fixture 17 is rotatably mounted on the second arm 15. The installation position 3 is formed between the first mounting fixture 16 and the second mounting fixture 17. A wire channel 11 is provided within the first arm 14, and the first outlet port 13 is arranged on the first arm 14.

In some aspects, the second arm 15 is equipped with a tilt drive assembly 18 that drives the rotation of the second mounting fixture 17 to adjust its pitch angle. The tilt drive assembly 18 is drivingly connected to the second mounting fixture 17. The wire channel 11 can include a first wire channel 111 and a second wire channel 112. The electrical wires 5 can include a first wire 51 and a second wire 52. The first wire channel 111 can be located within the first arm 14, while the second wire channel 112 can be located within the second arm 15. The first wire 51 and the second wire 52 can be respectively arranged within the first wire channel 111 and the second wire channel 112. The first wire 51 is electrically connected to the first outlet port 13, and the second wire 52 is electrically connected to the tilt drive assembly 18. Furthermore, the end of the first wire 51 opposite the first outlet port 13 and the end of the second wire 52 opposite the tilt drive assembly 18, both extend into the housing cavity 12 and can be electrically connected to the first circuit board 121. In some aspects, the housing cavity 12 is provided with a first wiring hole 124 and a second wiring hole 125 on its respective sides. The first wire 51 and the second wire 52 extend into the housing cavity 12 and can be electrically connected to the first circuit board 121 through the first wiring hole 124 and the second wiring hole 125, respectively.

In some aspects, the tilt drive assembly 18 includes a motor 181 and a third circuit board 182. The motor 181 is electrically connected to the third circuit board 182, and the second wire 52 within the second wire channel 112 is electrically connected to the third circuit board 182.

In some aspects, the first arm 14 is equipped with a first telescopic section 141 capable of extension and retraction, and the second arm 15 is equipped with a second telescopic section 151 capable of extension and retraction. The first wire 51, corresponding to the first telescopic section 141, and the second wire 52, corresponding to the second telescopic section 151, can be both provided with a first elastic segment 53 capable of extension and retraction. In some aspects, the first elastic segment 53 can be formed by coiling the wire, giving it an overall spiral shape that enables it to be stretched out, retracted, and coiled. It can extend or retract synchronously when the first arm 14 and the second arm 15 are extended or retracted. The telescopic structures of the first telescopic section 141 and the second telescopic section 151 can be of various types, such as a multi-section telescoping structure, for extension and retraction.

In some aspects, the support frame 1 further includes a connecting body 19. One end of the first arm 14, opposite the first mounting fixture 16, is bent to form a first connection end 142. Similarly, one end of the second arm 15, opposite the second mounting fixture 17, is bent to form a second connection end 152. The first connection end 142 and the second connection end 152 can be connected via the connecting body 19, giving the support frame 1 an overall “U” shape.

In some aspects, the first connection end 142 and the second connection end 152 can be telescopically and movably connected via the connecting body 19. The first wire 51, corresponding to the first connection end 142, and the second wire 52, corresponding to the second connection end 152, can be both provided with a second elastic segment 54 capable of extension and retraction. In some aspects, the second elastic segment 54 is formed by coiling the wire, giving it an overall spiral shape that enables it to be stretched out, retracted, and coiled. It can extend or retract synchronously when the first connection end 142 and the second connection end 152 are operated telescopically and movably at the connecting body 19. The telescopic structures of the first connection end 142 and the second connection end 152 can be of various types, such as the connecting body 19 being telescopically and movably sleeved with the first connection end 142 and the second connection end 152, respectively, for extension and retraction.

The above descriptions represent exemplary embodiments of the present disclosure and should not be construed as limiting the scope of the present disclosure. Any modifications, equivalent substitutions, and improvements made within the spirit and principles of the present disclosure shall fall within the protection scope of the present disclosure.

As used in the claims, the indefinite articles “a” and “an” should be understood to mean “one or more” unless explicitly stated otherwise or unless the context clearly dictates a singular interpretation. The use of these articles does not limit the claimed invention to a single instance of the referenced element but rather encompasses multiple instances where applicable.

What is claimed is:

1. A lamp stand comprising a support frame with an installation position configured to install a light fixture;
wherein a wire channel and a housing cavity are provided inside the support frame, a first circuit board is provided within the housing cavity, the wire channel is interconnected with the housing cavity, and one or more electrical wires are provided within the wire channel; and
wherein a first outlet port configured to electrically connect with the light fixture is provided on the support frame proximate to the installation position, the first outlet port is electrically connected to the one or more electrical wires, and one end of the one or more electrical wires away from the first outlet port extends into the housing cavity to connect with the first circuit board electrically.

2. The lamp stand according to claim 1, wherein the support frame comprises a first arm and a second arm;
wherein a first mounting fixture is rotatably provided on the first arm and a second mounting fixture is rotatably provided on the second arm; and
wherein the installation position is formed between the first mounting fixture and the second mounting fixture, the wire channel is provided within the first arm, and the first outlet port is provided on the first arm.

3. The lamp stand according to claim 2, further comprising a tilt drive assembly within the second arm, the tilt drive assembly configured to drive the second mounting fixture to pitch, the tilt drive assembly being drivingly connected to the second mounting fixture;
wherein the wire channel comprises a first wire channel and a second wire channel;
wherein the one or more electrical wires comprise a first wire and a second wire, the first wire channel is provided within the first arm, the second wire channel is provided within the second arm, and the first wire and the second wire are respectively provided within the first wire channel and the second wire channel; and
wherein the first wire is electrically connected to the first outlet port, the second wire is electrically connected to the tilt drive assembly, and one end of the first wire away from the first outlet port and one end of the second wire away from the tilt drive assembly both extend into the housing cavity to electrically connect with the first circuit board.

4. The lamp stand according to claim 3, wherein the first arm and the second arm are respectively provided with telescopic sections;
wherein a plurality of first elastic segments are provided at positions of the first wire corresponding to the telescopic sections and positions of the second wire corresponding to the telescopic sections.

5. The lamp stand according to claim 3, wherein the support frame further comprises a connecting body; and
wherein a first connection end is formed by bending one end of the first arm away from the first mounting fixture, a second connection end is formed by bending one end of the second arm away from the second mounting fixture, and the first connection end and the second connection end are connected via the connecting body.

6. The lamp stand according to claim 5, wherein the first connection end and the second connection end are flexibly and telescopically connected via the connecting body; and
wherein a plurality of second elastic segments are provided at positions of the first wire corresponding to the first connection end and positions of the second wire corresponding to the second connection end.

7. The lamp stand according to claim 1, further comprising a control box;
wherein the control box is connected to the support frame, a second circuit board and a third wire are provided within the control box, and a connection port penetrating through to the housing cavity is provided on the support frame;
wherein a connection channel is provided on the control box, the connection channel is connected to the connection port, and the third wire is electrically connected to the second circuit board; and
wherein one end of the third wire away from the second circuit board passes through the connection channel and the connection port to electrically connect with the first circuit board.

8. The lamp stand according to claim 7, wherein a wire clamp is further provided within the housing cavity, and one end of the third wire away from the second circuit board sequentially passes through the connection channel, the connection port, and the wire clamp to electrically connect with the first circuit board.

9. The lamp stand according to claim 7, wherein an access port configured to electrically connect with an external control console is provided on the control box, and the second circuit board is electrically connected to the access port.

10. The lamp stand according to claim 9, wherein a second outlet port configured to connect with other lamp stands is provided on the control box, and the second outlet port is electrically connected to the second circuit board.
